(19) United States
(12) Patent Application Publication
(10) Pub. No.: US 2024/0086949 A1
(43) Pub. Date: Mar. 14, 2024

(54) Geoscalar Polling System

(71) Applicant: Groma, LLC, Boston, MA (US)

(72) Inventors: Seth M. Priebatsch, Boston, MA (US); Christopher M. Lehman, Boston, MA (US)

(21) Appl. No.: 17/944,593

(22) Filed: Sep. 14, 2022

(51) Int. Cl. G06Q 30/02

(52) U.S. Cl. CPC G06Q 30/0203; G06Q 30/0205

(57) ABSTRACT

Embodiments of the invention are directed to a computer implemented method, and system for polling (public opinion voting, etc.) and generating a multivariate population map. The method divides users based upon their geospatial attributes into groups and securely stores, on a distributed ledger, user responses to a query. The method computes a group response for each created group of users, the group responses providing information on the opinions of users, with the specific geospatial attributes. This enables the method to identify and isolate the preferences of sections of the public often excluded from traditional public policy decision making processes. Further, the method uses blockchain technology to ensure the security of the provided responses and the anonymity, if desired, of the users.

### BACKGROUND

A common solution in large format decision making situations is to take votes or polls to gather a collective opinion. Standard polling and voting mechanisms fall short in scenarios where there is a desire to view separately or to weight votes differently based on attributes of the responding entities, including users, while maintaining the security and anonymity of those responding. One specific example scenario may be a vote being taken to determine opinions on a development in a city. In such a scenario, it might be desirable to isolate or weight votes, based on distance from the development or proposed project.

A need exists to expand the ability of local governments, developers, and other public decision makers to gather responses or votes from those beyond the narrow set of residential and business interests traditionally involved in local politics and decision making. In particular, a city's approval process for housing development is often byzantine and restricted to individuals with a financial interest or incentive and the ability to participate in local town and city meetings. Such an expansion of opinion gathering requires a process that is both secure and transparent, while enabling digital participation that protects anonymity.

### SUMMARY

Embodiments of the invention enable users to vote on queries or polling questions, such as a series of local governance/development questions (e.g. a proposed apartment building or a change in zoning to allow certain developments, for non-limiting example). The user's responses are anonymous while also being categorized and, in some embodiments, weighted according to the individual user's geospatial attributes. Responses and associated weighting and geospatial attributes enable relevant decision makers to take available information into account when deliberating on the issue at hand. In other words, embodiments of the invention are able to provide anonymized but segmented responses to a posed query. For any given query or proposed project, the decision maker, e.g. a city council, would be able to isolate responses from and choose to weight responses of a proposed project's closest neighbors, for non-limiting example, more heavily than responses of residents elsewhere in the municipality, which in turn could be weighted more heavily than responses of residents of other parts of the state, which in turn could be weighted more heavily than responses of residents of other states.

Embodiments of the invention include algorithmic mechanisms, and associated systems, that are able to automatically divide users into groups, cohorts, or subsets based on geospatial or other types of attributes of users such as place of residence and place of work. Responses to a query are derived for each of the created groups, cohorts, or subsets based on responses of users assigned to that group, cohort, or subset. The results can be displayed to provide insight regarding the polled users' opinions and preferences and reveal trends that may be hidden by merely polling the group of users as a unitary element. Furthermore, a unitary response to the query that is attributable to a group containing all of the polled of users can be constructed by applying a respective weight to a response of each created group, cohort or subset. Users divided into groups, cohorts, or subsets most relevant to the query, e.g. user located relatively closer to a potential development or zoning ordinance, can have their response granted greater weight than users grouped into less relevant cohorts. Relevance weighting enables construction of a unitary response that accounts for multivariate parameters. To ensure security, the algorithmic mechanisms can be implemented based on and using the blockchain to create a secure and immutable system of soliciting, recording, and weighting votes or responses. Furthermore, individual user responses can be kept anonymous, while ensuring the security and accuracy of each received response. Blockchain technology can also be utilized to ensure that the polling process remains secure and each user's response is verified and protected despite being received digitally.

An embodiment is directed to a computer-implemented method of generating a multivariate population map. The method includes, for each entity of a population, (i) automatically assigning the entity to a group based on geospatial attributes of the entity, the automatic assigning resulting in one or more groups, (ii) digitally receiving an individual response of the entity to a query, and (iii) immutably storing the received individual response in computer memory accessible by one or more processors. Then the method continues by for each group of the resulting one or more groups, automatically computing a group response, the group response being automatically computed by the one or more processors and being a function of the stored individual responses received from entities assigned to the group and rendering a multivariate population map displaying indications of the computed group responses.

The method may also comprise computing a unitary response of the population, the one or more processors automatically computing the unitary response as a function of stored individual responses of each entity multiplied by a weighting factor associated with the group to which the entity is assigned, there being different weighting factors for different groups. In such embodiments, the population map also displays indication of the computed unitary response.

The entities of the population may be individuals, i.e., polled users, voters, and the like. The resulting one or more groups may be one of: regional groupings, socioeconomic groupings, and statistical subpopulations. The geospatial attributes may include one of a location of residence, a location of work, or a location of interest.

The query can be associated with query attributes and automatically assigning the entity to a group for each of the entities is further based on the query attributes. In such embodiments, the query attributes can be geospatial attributes.

The population map can be a geographical map. In such embodiments, rendering includes overlaying the displayed indications on the geographical. The individual responses to the query can be anonymous. The computer memory may be located on at least one block of a blockchain.

In another embodiment, a computer-based polling system embodies the principles of the present invention. The polling system comprises one or more digital processors, a polling engine, and a mapping member. The one or more digital processors support a communications interface or similar user interface with entities in a population. The polling engine is executed by the one or more digital processors, and for each entity of the population, the polling engine: (i) automatically assigns the entity to a group based on geospatial attributes of the entity, the automatic assigning resulting in one or more groups, (ii) digitally receives an individual response of the entity to a query, and (iii) immutably stores the received individual response in a ledger accessible by the processor(s). The mapping member is responsive to the polling engine and is executed by the one or more digital processors. For each group of the resulting one or more groups, the mapping member automatically computes a group response as a function of the stored individual responses received from entities assigned to the group. The mapping member renders a multivariate population map displaying indications of the computed group responses.

Another embodiment is directed to a computer based system that generates a multivariate population map, the system comprising a processor and a memory with computer code instructions stored thereon. The computer code instructions are configured to cause the system, for each entity of a population to: (i) automatically assign the entity to a group based on geospatial attributes of the entity, the automatic assigning resulting in one or more groups, (ii) digitally receive an individual response of the entity to a query, and (iii) immutably store the received individual response in a ledger accessible by the processor. The computer code instructions are further configured to cause the system to automatically compute a group response for each group of the resulting one or more groups. A subject group response is automatically computed by the processor and is computed as a function of the stored individual responses received from entities assigned to the group. Further computer code instructions cause the system to render a multivariate population map displaying indications of the computed group responses.

The computer code instructions can be further configured to cause the system to compute a unitary response of the population, the processor automatically computing the unitary response as a function of stored individual responses of each entity multiplied by a weighting factor associated with the group to which the entity is assigned, there being different weighting factors for different groups. In such embodiments, the population map also displays indication of the computed unitary response.

The entities of the population may be individuals, polled users, registered voters, and the like. The resulting one or more groups can be one of: regional groupings, socioeconomic groupings, and statistical subpopulations. The query may be associated with query attributes and automatically assigning the entity to a group for each of the entities is further based on the query attributes. Additionally, the query attributes can be geospatial attributes.

The population may be a geographic map. The individual responses to the query may be anonymous. The ledger can be located on at least one block of a blockchain.

An embodiment of the invention is directed to a computer program product for generating a multivariate population having one or more non-transitory computer-readable storage devices and program instructions stored on the one or more storage devices. The program instructions, when loaded and executed by a processor, cause an apparatus associated with the processor to, for each entity of a population (i) automatically assign the entity to a group based on geospatial attributes of the entity, the automatic assigning resulting in one or more groups, (ii) digitally receive an individual response of the entity to a query, and (iii) immutably store the received individual response in a ledger accessible by the processor. Further program instructions, when loaded and executed by the processor, cause the apparatus associated with the processor to, for each group of the resulting one or more groups, automatically compute a group response, the group response that is automatically computed by the processor being a function of the stored individual responses received from entities assigned to the group. The program instructions when executed by the processor cause the associated apparatus to render a multivariate population map displaying indications of the computed group responses.

The program instructions, when loaded and executed by a processor, may cause the apparatus associated with the processor to additionally compute a unitary response of the population, the processor automatically computing the unitary response as a function of stored individual responses of each entity multiplied by a weighting factor associated with the group to which the entity is assigned, there being different weighting factors for different groups. In such embodiments, the population map also displays indication of the computed unitary response.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic illustration of a blockchain utilized by embodiments of the invention.

FIG. 1B is a block diagram of an example embodiment of a system for creating and managing transactions on the blockchain of FIG. 1A.

FIG. 2 is a schematic illustration of a set of users divided into groups by a polling engine in an example embodiment of the invention.

FIG. 3 is a schematic illustration of the output of an embodiment of the invention showing the responses for a set of users divided into logical groups.

FIG. 4 is a flow diagram of a method for generating a multivariate population map in embodiments of the present invention.

FIG. 5 a schematic view of a computer network or similar digital processing environment in which the embodiments may be implemented.

FIG. 6 is a block diagram of the internal structure of a computer (e.g., client processor/device or server computers) in the computer network of FIG. 5.

### DETAILED DESCRIPTION

A description of example embodiments follows.

Embodiments of the disclosed invention assist public decision makers in expanding their ability to gather responses or votes, enhancing the ability of impacted individuals to provide valuable and reliable feedback and responses to proposals and related queries. It might also be desirable to establish a set of predefined regional groups relative to the development or proposed project. For example, historically, if an individual wanted to provide input on a proposed development, the individual would have to attend, in person, local government meetings scheduled to discuss the proposal. Current systems for receiving input does not favor those most affected by the proposal, but instead favors those that have the ability to attend meetings that are often long and at times that can be inconvenient. Individuals who are able be away from work or home responsibilities and those with a direct financial stake in the proposed project often constitute a large proportion of those able to participate in the process and attend and provide in person feedback and responses. As a result, wealthy individuals can be overrepresented in the process relatively speaking. In contrast, individuals with less resources are excluded. Finally, individuals who may benefit from a project in the future, including, for example, those who may eventually live in but do not currently live near the project, are excluded entirely. This can lead to undesirable barriers to public participation and undesirable public decision making results.

Additionally, the current system often provides an all or nothing approach with a minority of individuals perceived to be most affected by proposed development (abutters) or other public policy decisions (taxpayers or developers) are made aware of and have a disproportionate motivation to be involved, while a majority with a perceived weaker interest are excluded. Given the constraints of modern life (people are busy), only the people with the most concentrated interests in proposed plans tend to show up to local government meetings. The result is that decisions that might affect an entire city, or hundreds of theoretical residents, are often representative only of the nearest available neighbors, whose interests may or may not align with the broader perspectives as to the impact on the city. This creates a distorting impact because the average citizen does not have the time, paid time off, perceived return on investment to become involved in the public policy making apparatus. Further, the average citizen may not receive information timely to evaluate whether an issue is significant to the individual.

The disclosed invention further takes into account the fact that some individuals, due to their location, more generally geospatial factors, or other factors, e.g. the neighbors of a proposed new development, are more affected by specific proposals. Toward that end, embodiments of the invention allow for policy makers to receive input from specific groups, cohorts, or subsets of users, categorized by geospatial attributes. Such groups, cohorts, or subsets can be generated by an algorithm to output equally sized cohorts (either by number of participants or geographic area covered) or isochronal groupings such as travel distance (by some method of transport, i.e. foot, bike, car, public transit) to the subject location of the proposal. Additionally, in some embodiments, the groups, cohorts, or subsets may be subdivisions of other groups, cohorts, or subsets either based upon more specific geospatial attributes or other attributes (e.g., demographics). Results from these groups, cohorts, or subsets may be presented in such a manner as to provide greater insight into the perspectives of those polled, i.e. a total vote (yes/no of all participants) can then be overlaid visually, on top of or over the geographic regions that define the groups, cohorts, or subsets. Other visual effects, color coding, or the like are suitable. Each region can user-selectively or otherwise display the vote, tally ratios, etc. Additional vectors and properties of the groups, cohorts, or subsets can also be rendered or user-selectively displayed, for example, to indicate the relative geographic regional size (in two-dimensional space units), population size (in number or density units), or a combination of vectors (for example a representation of three-dimensional space units and density units). Furthermore, based on user inputs or responses, a total “scoring”, i.e. vote count proximity, can be displayed alongside the regions. In this way, embodiments of the invention provide a plethora of additional information to public policy makers that takes into account entities that are not limited to those who shows up or those who vigorously participate in a local town hall meeting. By enabling digital participation and relevance weighting, for example, a broader cross-section of the general public is able to provide input and responses to queries using embodiments of the invention.

Embodiments of the invention include a blockchain based system that is able to: (i) divide polled respondents into groups, cohorts, and/or subsets, for example, based on geospatial attributes, (ii) receive individual responses to a query, and (iii) immutably store the received individual responses. Data is stored regarding a user's attributes, for example, home location, work location, name, address, age, income, etc. This data may be stored as a user profile created at the time of the user's enrollment in the system or another connected system. The user profile may also include a user ID that can specifically, but with anonymity, identify the user. The stored user's attributes and profile can remain non-public and the user's identity kept anonymous. The user ID can be proven to belong to a specific user, without revealing underlying information about the user, e.g. the other information in the user's profile, by utilizing a zk-SNARK method, or another functionally similar method.

The system is able to receive, via a polling engine in some embodiments, a user's response to a posed question or query and securely (immutably) store that response on a block of a blockchain. The system may also store, or point to, or otherwise indicate the user's ID along with the user's response on the block of a blockchain. This may be accomplished via executing a smart contract configured accordingly. Blockchains are a distributed ledger technology that allows for mutual verification, approval, and sharing of transaction records among nodes distributed at multiple hubs on a computer network. Blockchains allow for: (a) decentralized transactions that do not rely on a third party's trust (direct transactions between participants are possible), (b) the creation of resilient networks due to mutual data/system management, and (c) the prevention of tampering with recorded data (only new entries can be added by design, control over the recording of new data or records as new entries requires consensus among transaction parties, and fraudulent entries are rejected by parties). Smart contracts are transaction conditions programmed and incorporated into blockchains that, when the predetermined contract conditions are met (e.g., a response to the polling question is sufficiently entered by a registered user), the transaction is automatically performed (e.g., the user's ID and response are recorded on the block chain). Embodiments of the invention may also allow stored data to be viewed and verified by third parties to enable public verification of the queries' results.

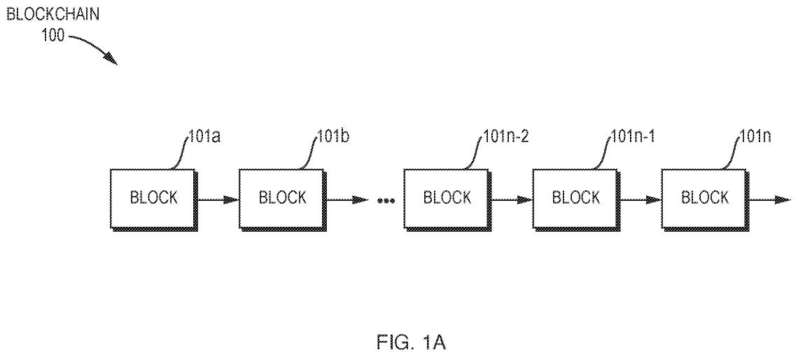

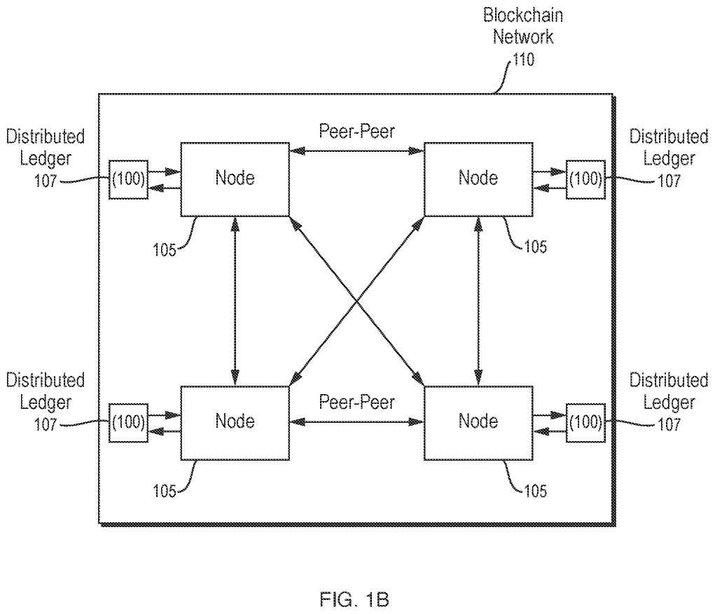

FIG. 1A is a schematic illustration of a blockchain 100 utilized by embodiments of the invention. In particular, methods and systems embodying the present invention utilize blocks 101 of a blockchain 100 to store data, for example a user's response to a query and an indication of their user ID. A blockchain 100 is a public, secure, distributed, cryptographically-proven ordered list. Illustrated blockchain 100 is comprised of multiple blocks 101a, 101b, . . . 101n (generally referenced 101 throughout this disclosure). The first block 101a is known as the genesis block. After the genesis block 101a, each block refers back to the previous block (its predecessor block 101) in the chain. This is illustrated with arrows between the blocks 101. For example, block 101b refers back to block 101a and so on. Referring back can be done in a variety of ways, e.g., by including some part of the previous block, e.g., an identifier or its consensus proof, or a value computed over the previous block, e.g., a hash, a signature, etc. A blockchain is often used for a specific type of ordered list, an ordered list of transactions called a ledger. In such a use case, each block 101 may include a record of the query asked and the response(s) received. A blockchain 100 may include records of one or more transactions. Some embodiments, may allow blocks 101 with zero transactions, e.g., to support timely delivery of new blocks. When used as a ledger, a blockchain 100 can provide verification for a sequence of transactions.

Blockchain 100 is also provable. Using cryptography, it can be ensured that each block 101 is complete before the next block (its successor block 101) is initiated. For example, if the blockchain 100 is an ordered ledger with blocks 101 representing individual transactions, then the blockchain verifies that the transaction recorded by block 101b is completed before verifying that the transaction recorded by block 101c is completed. This is extremely useful in creating records for transactions that have cause and effects, e.g., a query is posed to a set of users, recorded in block 101b, and then the users provide a response to the query, recorded in block 101c. The ordered nature of the blocks 101 allow for proof that a specific response was provided for a specific query. Typically, each of the blocks 101 comprises a consensus proof, computed over one or more transactions. The consensus proof is a cryptographic signature that establishes each block's completeness and location in the blockchain 100. In some embodiments of the invention, the consensus proof is created by using a cryptographic kernel that generates a public/private key pair. Various equivalent Cryptographically Secured Distributed Ledger technologies may be used such as: Blockchain, Hashgraph, Directed Acyclic Graph, etc., as such technologies support the same concepts: consensus algorithms, cryptocurrencies, tokens, etc.

Another key feature of blockchains 100 is that they are logically distributed. Blocks 101 may be stored on different devices (computer memory) in different locations. However, these blocks are still operatively connected in the blockchain 100 due to their cryptographic signature. Additionally, blocks 101 may be accessed and viewed from different devices in different locations. This enables third parties not part of a transaction recorded on the blockchain to view and verify that the transaction has occurred. Additionally, because of the security provided by the block's cryptographic signatures, the blockchain 100 and its component blocks 101 cannot be distrusted or altered. This enables the blockchain 100 and individual blocks 101 to be reliable and trustworthy records despite their distributed nature. Another level of security is added due to the public nature of blockchain 100 and its blocks 101. Since the blockchain is public, many copies of it and/or its component blocks can be created. These copies would naturally also have the cryptographic signatures in the blocks 101. Therefore, even if one copy of the blockchain 100 or blocks 101 was manipulated by a bad faith actor, the other copies could be used as a verification tool to exclude incorrect data as manipulating all public copies would be difficult if not impossible.

Blockchains provide the ability to track transactions for networks with thousands or even millions of geographically dispersed people who might not know, let alone trust, each other. Blockchains enable trustless transactions without the need for a centralized authority. Embodiments of the present invention utilize blockchains as part of a novel and unique approach to create verifiable records of queries asked and responses received, such as, government agency polls, ballot questions, elections, and the like. Because of the secure and immutable nature of blockchains, the responses are able to be trusted even if the users providing them remain anonymous. Data memorializing the queries posed and responses of users can be stored on one or multiple blockchain 100 blocks 101. Data, such as user ID that can be used to associate a user's response with stored information about the user, without identifying them can also be stored on one or multiple blockchain 100 blocks 101 either with or independent of the other data. Finally, because of the transparency, security and verifiability of the data stored in blocks 101 in the blockchain 100, it can be used by third parties to verify the query responses to ensure that accurate information is presented. This enables decision makers to rely upon and trust the received query responses even if the individual users remain anonymous. The blockchain 100 and its component blocks 101 can serve as a secure proof of the opinions of the polled users due to the blockchain's security features. This can expand access to the public decision-making process beyond the individuals with the ability, or financial incentive, to attend in person local meetings.

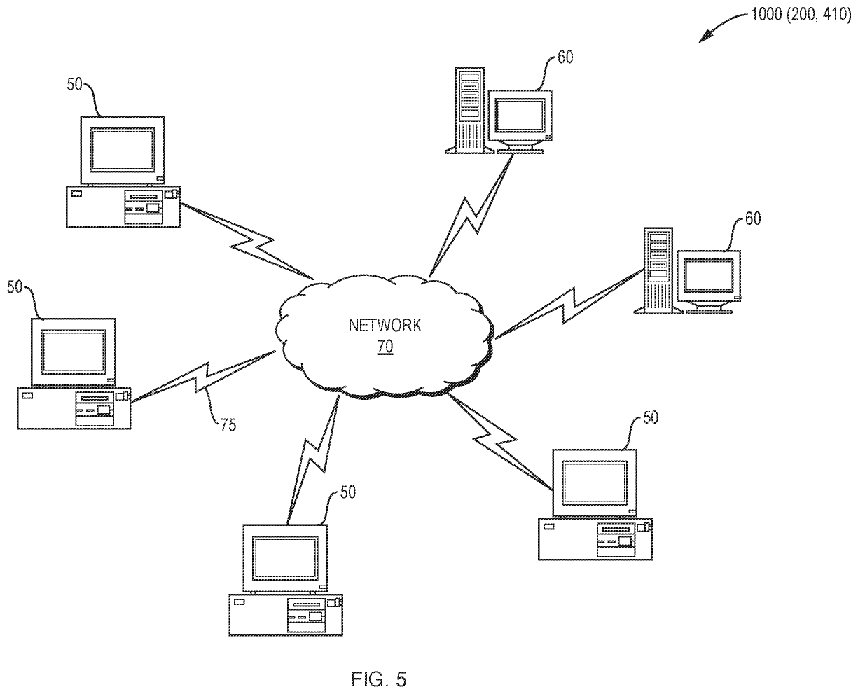

FIG. 1B is a block diagram of an example embodiment of a system for creating and managing transactions on a blockchain 100 utilized by embodiments of the invention. The system comprises a blockchain network 110 with a plurality of nodes 105. The nodes 105 may be in peer to peer communication with each other and implemented by computer nodes (clients, servers, devices, etc.) 50, 60 in a computer-based network described later in FIG. 5. Each node 105 in the blockchain network 110 may contain a distributed ledger 107 that includes a copy of the blockchain 100. Transactions, that are recorded on the blockchain 100 are recorded in the distributed ledgers 107. Nodes 105 may view and verify the distributed ledgers 107 located on other nodes 105.

In some embodiments of the invention, the blockchain 100 utilized is the Ethereum blockchain. Ethereum is a vibrant, battle-tested ecosystem that facilitates trustless transactions. However, a person skilled in the art should understand that embodiments of the invention could be implemented on a wide variety of currently existing blockchains and be adapted for blockchains developed in the future. In some embodiments, including those that utilize the Ethereum blockchain 100, a variety of smart contracts can also be used to automate transactions and store records of them on the blockchain blocks 101 in distributed ledgers 107. The smart contracts can function to pose a query to a user (such as a registered voter, registered resident, and the like) and automatically record a received response on the blockchain blocks 101 in distributed ledgers 107. The smart contracts can also function to automatically store an indication of a user's user ID along with the received response on the blockchain blocks 101 in distributed ledgers 107. The stored user ID indicia (for non-limiting example, a pointer, link, or other representation) can be used to connect the user's responses with the stored information about the user, without revealing the user's identity. These smart contracts can be stored on and executed using the Ethereum, or equivalent, blockchain and architecture. The smart contracts can also be automatically executed increasing reliability and trust in the preformed transactions, despite the distributed nature of the blockchain. In one embodiment, a polling engine includes the smart contracts and blockchain.

Before or after the user's responses have been received and stored on blocks of the blockchain 100, an embodiment system divides the users into logical groups, cohorts, and/or subsets. This may be done automatically by a processor or other computer based upon the stored user information and/or properties (attributes) of the individual. In some embodiments, this division is done based on the user's stored geospatial attributes' relation to the query posed. As a non-limiting example, in the instance of a query posed about a proposed building at a specific address, seven default polling groups can be defined in relation to the query that address space-based or physical aspects as follows:
i. Immediate neighbors
ii. 0.1 mile radius
iii. ZIP code
iv. Municipality
v. Metropolitan statistical area
vi. State
vii. Country

The system processor (or polling engine) then assigns each polled user to one of the seven predefined groups based upon their stored geospatial attributes. The stored geospatial attributes may be part of a user's profile stored in a database, a relational or other organized (indexed) memory area, or other data store, accessible by the processor. The above predefined groups are merely a non-limiting example. Embodiments of the invention are able to create customized groups, cohorts, or subsets, in addition to or as an alternative to the aforementioned seven groups, based on the preferences of the provider of the query or the characteristics of a specific query. For non-limiting example, groups, cohorts, and/or subsets could also be determined based upon lateral distance to a location or travel distance to a location. Embodiments of the invention may also utilize an algorithm to automatically determine groups, cohorts, and/or subsets based on information (such as demographics) gathered about the polled users. The algorithm may determine groups, cohorts, and/or subsets based on evenly dividing the users into a desired number of groups or to create groups with a desired number of users.

Additionally, the groups, cohorts, and/or subsets may be derived manually or automatically using an algorithm to ensure users with specific attributes, e.g. age or income, are sufficiently represented. This can be done to help provide a voice to individuals and those of demographics that may otherwise be excluded from traditional public decision making processes. For example, historically minority and low-income communities and individuals have been purposefully and indirectly prevented from participating in local planning decisions. Embodiments of the invention may be configured to divide users into groups, cohorts, and/or subsets based on geospatial attributes while also ensuring that each created groups, cohorts, and/or subsets has sufficient representation of traditionally underrepresented users.

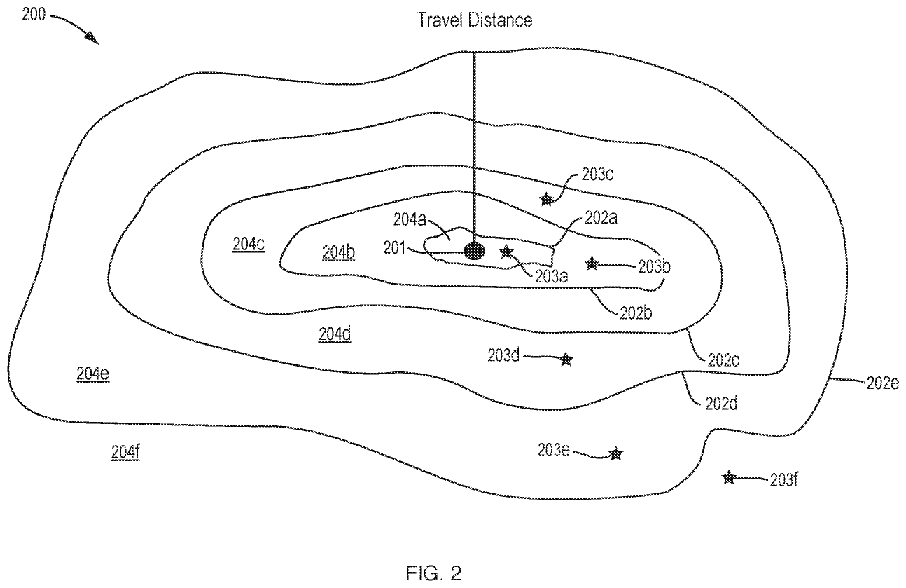

FIG. 2 is a schematic view of polling engine 200 dividing a set of users 203a, 203b, . . . 203f (collectively 203) into groups in an example computer-based system embodying the present invention. FIG. 2 illustrates a geographic representation of the location of users 203 in relationship to a location of interest (or at issue) 201. Subject Location 201 is a location relevant to a proposed query, for non-limiting example, location 201 can be the address of a proposed development, zoning change, public works project etc. The polling engine 200 or more generally the computer-based system embodying the present invention can gather and categorize responses of users 203a, 203b, . . . 203f to the query related to subject location 201. Each user 203 has geospatial attributes, represented and stored on a computer memory accessible by a processor of the computer-based system. These geospatial attributes may include the location or addresses (business/work, residence, school, etc.) of the user 203. Each user 203 also has a user ID (or an indication thereof) stored on the memory accessible by the processor that can be used to anonymize the user. Stored geospatial attributes of users 203 can be verified while retaining their anonymity through the use of a common in the art KYC (know your customer) method. The KYC method may be implemented by a smart contract stored on blocks 101 of a blockchain 100.

The processor (polling engine 200), or other computing device, uses the stored geospatial attributes of the users 203 to compute a relationship to subject location 201. In the example embodiment shown in FIG. 2, the computed relationship is travel distance. The processor (polling engine 200) also establishes group boundaries 202a-202e (collectively 202), algorithmically, based on preset group definitions or based on a received input. The group boundaries 202 may be, for example, the default polling regions or groups i to vii set forth hereinabove. The group boundaries 202 circumscribe and define geographical areas 204a-204f (collectively 204). The processor (polling engine 200) sorts users 203 into geographical areas 204 based on stored geospatial attributes of the users. Each geographical area 204 has a different spatial relationship (or travel distance range) to subject location 201. Therefore, users 203, which are located within different geographical areas 204, will be affected differently for any proposed event at subject location 201.

For example, users 203, for example user 203a, in geographical area 204a (having shortest travel distance range to subject location 201) will be highly affected by a proposed development at location 201, while users 203, for example user 204e, in geographical area 204e (having further travel distances from subject location 201) will be less effected. Traditionally, if a building was proposed at subject location 201, the users 203 residing in area 204a and maybe 204b would be highly motivated to be involved in the public planning process. Additionally, users 203 located further away, e.g. in area 204f, but with a financial stake in the project, would also be highly motivated to be involved in the public planning process. However, users 203 located further away from subject location 201, but near enough to be minorly affected, e.g. users in geographical areas 204c and 204d, would traditionally be completely uninvolved in or even unaware of the public planning process. This would permit a small group of highly motivated individuals to dominate the public planning process even if they were significantly outnumbered by less motivated, but still affected, individuals located further away. An increasingly common negative result of the current process is the ability of an immediate (user 203a) neighbor to stall or prevent developments that could benefit many people living slightly further away (users 203b-203e). In contrast, embodiments of the present invention allow for a group of users 203 to provide their response to a query about subject location 201 and for the users 203 and their responses to be stratified or otherwise categorized into geographical areas 204 based on their geospatial attributes relative to subject location 201. As a result, public decision makers are able to gain information and responses from all types of users 203, rather than those who are informed of and traditionally incentivized to participate in the planning process. Furthermore, by providing a digital system for receiving responses from users 203, while also storing those responses on blocks 101 of blockchain 100, the barrier to participation is significantly reduced and effectively leveled (all users have equal ability to be heard and have a ‘say’/voice) while also ensuring voter response security and anonymity.

After users 203 are assigned to geographical areas or groups 204, the computer-based system (polling engine 200) stores a group assignment or ID for each user either on blocks 101 of blockchain 100 or on different data storage architecture, such as a suitably configured computer memory. Embodiments of the invention provide the ability to combine responses to the query received from users 203, with users 203 sorted into groups based on their geospatial or other attributes to provide a significant improvement in the amount of information presented to public policy makers or other entities providing the query. Embodiments of the invention enable data presentation along multiple population vectors or variables, including the combination of variables. Users 203 can be assigned, via polling engine 200 in embodiments, to groups 204 based on at least one of their attributes. If attributes of a user 203 change or are updated, some embodiments of the invention are able to re-assign the user to a new group 204 that fits their updated attributes. In the non-limiting example of FIG. 2, users are assigned to groups 204 based on distance to subject location 201. Group responses (per geographical areas 204) to a query can be determined based on the pertinent individual responses, stored on blocks 101 of blockchain 100, of users assigned to the group. For non-limiting example, the system computes the group response by summing the stored individual responses of users 203 assigned to the geographical area/group. Furthermore, a total or unitary response for all users 203 can be determined based on the individual responses, stored on blocks 101 of blockchain 100, of users 203 who provided responses. By controlling how users 203 are assigned to groups 204, the system can collect, determine, and display a view of the poll responses and related information that may be ignored in the traditional in-person public decision making processes. For example, the opinions of intermediate distance users 203c and 203d of geographical areas/groups 204c and 204d are often ignored or excluded due to lack of notice, lack of understanding of significance, or lowered motivation to participate in lengthy in person planning meetings. Embodiments of the present invention can reduce barriers to participation (and effectively level or equalize participation) by digitally, but securely, receiving responses and calculating a group response that is not dependent on the more motivated or louder users (203a and 203b) who may have a disproportionate stake in the outcome.

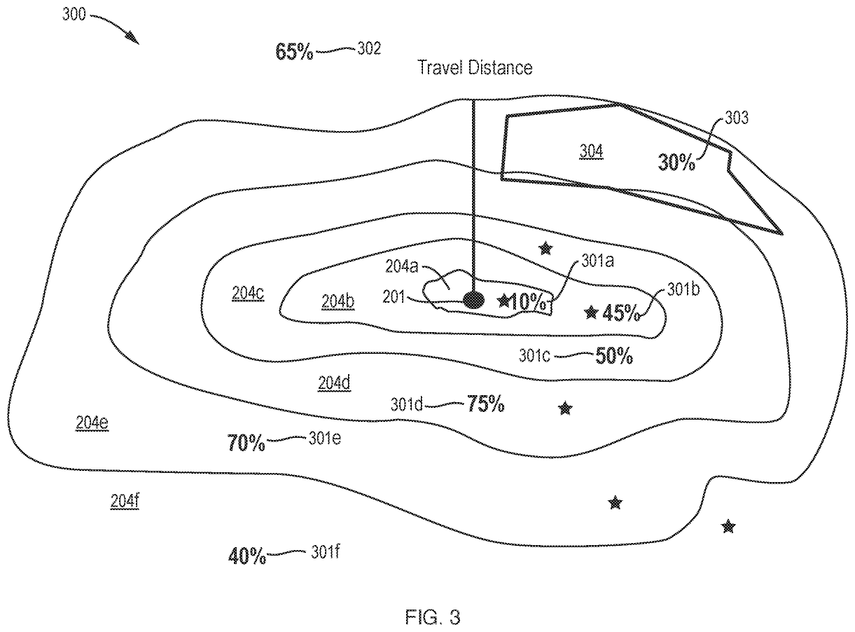

FIG. 3 is an illustration of the output of a computer-based system embodying the present invention showing the responses for a set of users 203 divided into groups 204. The system (polling engine 200) divides users 203 into groups 204a-204f based on distance from subject location 201 as described above and shown in FIG. 2. In some embodiments, user's may also be assigned into cohorts or subsections, for example subsection 304. The subsections and/or cohorts may be subdivisions within groups 204, across groups 204, or an alternative to groups 204. The subsections and/or cohorts can be determined using alternative user attributes, demographics and/or information than groups 204. For non-limiting example, subsection 304 may be composed of users 203 within group 204e with select demographics such as age, income, etc. The subsections and/or cohorts 304 can be utilized by embodiments of the invention to isolate and promote users 203 traditionally excluded from the public planning process.

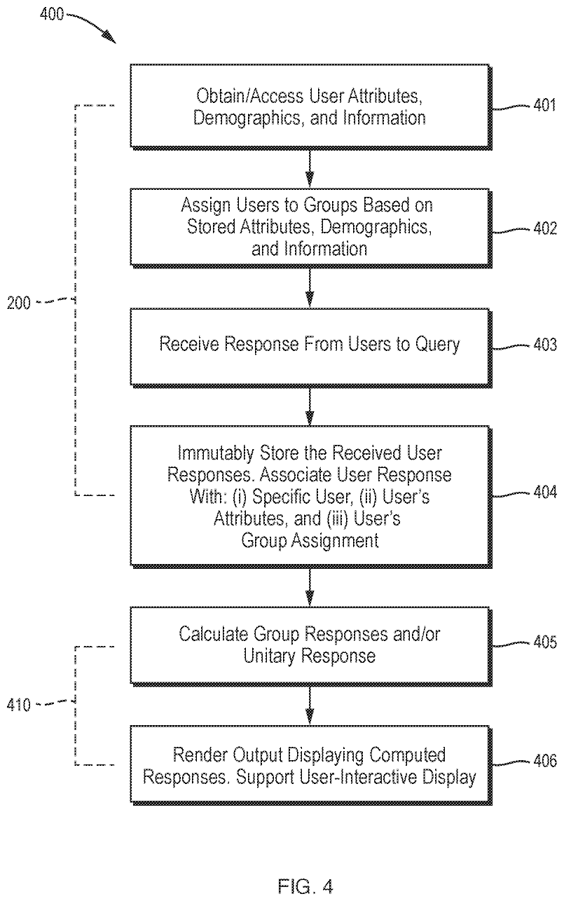

Either before or after that division, the users have provided a digital response to a provided query (poll question). In the embodiment shown in FIG. 3, the responses to a posed query are either a yes or no. The system (e.g., polling engine 200) stores the responses of users 203 on blocks 101 of the blockchain 100 ensuring that they are immutable, secure, and publicly verifiable. The system associates respective responses with each user 203 and their assigned groups 204. Response-user association can be accomplished with an anonymous user ID also stored on blocks 101 of the blockchain 100. Using the stored and verifiable responses, the system processor (or a mapping member 410 of FIG. 4) calculates a group response 301a-301f (collectively 301) for each group 204a-204f, respectively, of users 203. Specifically, the group response 301a is based upon (or a function of) the responses of users 203a assigned to group 204a. The group response 301b is based upon (or a function of) the responses of users 203b assigned to group 204b; and so on for the other groups 204. Additionally, cohort and/or subsection responses, e.g., 303, can also be calculated based on users assigned to that cohort and/or subsection 304, and in the same manner as group responses 301. Cohort and/or subsection responses, e.g., 303, are calculated separately from group responses 301 and the response from a user assigned to both a group, e.g., 204e, and a cohort and/or subsection 304 will be utilized for the calculation of both the cohort and/or subsection responses, e.g., 303, and group response 301e.

In the embodiment shown in FIG. 3, the system processor (or mapping member 410) calculates the group responses 301 by determining the percentage of users 203 in the group 204 that responded “yes.” The system/mapping member 410 visually displays or otherwise renders group responses 301 (percent ‘Yes’) within or connected to each group 204 as a population map 300. This enables each group 204 and its group response 301 (percent ‘Yes’ for non-limiting example) to be displayed. The population map 300 may be a geographical map that clearly shows the geospatial relationship of each group 204 to the subject location (location at issue) 201 that is relevant to the query. The system/mapping member 410 may display each group 204 and, as calculated, its group response 301 using various indicia and formats such as in a table, on a visual overlay, on a geographical map, or other output format. Population map 300 shows responses to a query categorized based upon users' attributes and enables public policy makers to isolate responses of users with certain demographics, attributes, locations, and other aspects of interest, each as variables for the population map.

Embodiments of the invention (via mapping member 410) may also calculate and display a unitary response 302 that is calculated based on the responses of all polled users 203. Unitary response 302 may be displayed in a range of manners similar to group responses 301, including by overlaying the unitary response on a population map 300. The unitary response provides public policy makers with the collective opinion of users 203 who provided responses to the query. However, the unitary response 302 does not need to be a simple combination of all the group responses 301 or all the individual responses of users 203. As discussed previously, groups 204 are defined based on their geospatial relationship to subject location 201. Therefore, the response to a query related to location 201 should carry increased effect for users 203 located in groups 204a and 204b adjacent to location 201. While traditional in person meetings tend to allow only the most impacted users to provide their opinions to the exclusion of others who are impacted, which is undesirable, it may still be desirable to provide additional weight to responses of users 203 who are most impacted by the proposed project and posed query. To achieve this result, embodiments of the invention (mapping member 410), when calculating the unitary response 302, assign a weight to each group response 301a-301f or to each individual user response used to calculate the unitary response. Groups located closer to location 201 (i.e., groups having a relatively shorter travel distance to/from subject location 201), for example groups 204a and 204b, can be assigned greater weights than groups located further from location 201 (i.e., groups having a relatively farther travel distance to/from subject location 201), for example groups 204e and 204f. For non-limiting example, the system multiplies group responses 301a and 301b by a weight of 2.0 (assigned to corresponding groups 204a and 204b) when calculating unitary response 302, while multiplying group responses 301e and 301f by a weight of 0.5 assigned to corresponding groups 204e and 204f.

The system thus calculates unitary response 302 (UR) as:

UR=ΣwᵢXᵢ for i=group a through group f, Equation (1)

where wᵢ is the weight for group 204, and X₁ is group response 301. Then Equation (1) can be rewritten for the non-limiting example above as:

UR=2X_{(group response 301a)}+2X_{(group response 301b)}+(1)X_{(group response 301c)}+(1)X_{(group response 301d)}+(0.5)X_{(group response 301e)}+(0.5)X_{(group response 301f)}> Equation (2)

and group response Xᵢ=(Σwⱼyⱼ*)/(Σwⱼyⱼ) for j=user a through user f where wⱼ is optional weight for user 203, yⱼ* is positive individual response of user j assigned to group i, i.e., group 204, and yⱼ is any individual response of user j for each user in the group i. The weights assigned to each group 204 and used to calculate the unitary response 302 can be any desired multiplier or factor. By weighting the different group responses 301 differently when calculating unitary response 302, embodiments of the invention can elevate and prioritize the responses of the most affected or relevant users, e.g. 203a and 203b, while not excluding the responses from less affected users, e.g. 203e and 203f. In addition, by allowing users 203 responses to be received and stored digitally, the invention expands the accessibility of and enables greater public participation in public policy decision making while still acknowledging that certain individuals or users may be more affected than others and therefore entitled to relatively greater (i.e., weighted) input. Weights can also be chosen that account for increased numbers of users 203 providing responses as relative distance from subject location 201 increases. Weights, if any, applied to groups 204 and users 203 and the equations or algorithms for the calculation of unitary response 302 and group responses 301 can be stored on blocks 101 of blockchain 100 to increase transparency and ensure that calculations are not manipulated. Alternatively, weights, if any, applied to groups 204 and users 203 and the calculation of unitary response 302 and group responses 301 can be made known to users 203 in alternative ways, such as. for non-limiting example, publishing them online, providing them directly to users with the query, and other ways, to build trust in the polling process.

FIG. 4 is a flow chart of a method 400 for generating a multivariate population map in computer-based systems embodying the present invention. In at least one embodiment, steps 401 through 404 are implemented by polling engine 200, and steps 405 through 406 are implemented by mapping member 410. The method may begin with a system processor obtaining or otherwise accessing 401 attributes, demographics, and information of users. The users' attributes, demographics, and information may be previously stored or currently collected (such as over the internet or other computer communications network) and stored as user profiles in a computer memory or other data storage architecture accessible by computer processors that perform later steps of method 400. In some embodiments 400, the user attributes, demographics, and information may have previously been collected and stored by an external system or method. The users may provide their attributes, demographics, and information as part of a user profile in a user online registration process or in response to a set of inquiries by system/method 400, for non-limiting example. The system processor/method 400 generates and associates a User ID with the user's attributes, demographics, and information and uses the same to anonymize the user.

Next, the system processor/method 400 assigns 402 users to groups based on their stored attributes, demographics, and information. Assignment can be based upon the user's relationship to a location of interest (e.g. subject location 201) that is relevant to a query posed later in method 400. For example, the location of interest and subject of the query or poll may be the location of a proposed new development or zoning ordinance. The groups, and users' assignment to the groups, can be based on the geospatial attributes of the users in relation to the location of interest. The system/method 400 can create groups to divide users by any desired combination of user variables or attributes. A digital processor executes an algorithm known in the art to automatically determine groups and assign users to the groups. Alternatively, the groups may be manually specified and determined therefrom by the decision-makers or poll operators utilizing systems and methods 400.

Step 403 provides a query to users and receives, from users, responses to the posed query. This step 403 may be performed, in some embodiments, before, concurrently with, or after step 402. In particular, step 403 provides the query through a digital interface such as a website, smart application, software program, or text message. The users may in turn submit their responses through the digital interface. One or more processors coupled to the internet are configured to receive the responses and to support the digital interface. Persons skilled in the art are aware of a range of techniques and methods for implementing digital communication to users and submission of responses from users. Any such methods may be employed by step 403. Security and cryptographic methods may be utilized to protect both the identity of the user and the provided response.

In an alternative embodiment of the invention, instead of step 403 receiving a response from a user, step 403 automatically predicts or calculates the user response based on the stored user profile of the user. Then step 403 outputs the calculated response as input to step 404 of method 400. For some users, the barrier to participation in the public decision making process is due to an unfamiliarity regarding the specific issues at hand. Such users would find it challenging to provide a direct answer to a specific question, e.g. should zoning ordinance 45B be modified to 72F at 10 Example street. Embodiments of the invention enable the collection and storage of general policy-level user preferences, for example, anti-development, pro-public transit, pro-bike lanes, etc. These user preferences can be collected through a survey asking users about their opinions on broader topics, defined concepts, or big picture ideas. After the preferences are collected, they are stored in computer memory as part of or in connection with the user profile. A processor of system/method 400 is configured to analyze the provided user preferences and predict or otherwise generate a user's response to a specific poll question. For example, if the user preference (stored in computer memory) was generally for more bike lanes, then upon step 403 posing a query for approval of a specific bike lane, the system processor responsively determines that the user would want to respond in favor of the bike lane and generates an output of step 403 accordingly. In other words, embodiments of the invention are capable of automatically translating provided general/generic user policy preferences into responses to specific polling questions. A user authorizes embodiments of the invention to automatically calculate (derive or otherwise generate) and provide a response to a posed query based on that user's stored general policy preferences without the user providing a specific response to an individual query. These automatically calculated (processor derived or generated) responses on behalf of the user can be utilized by method 400 in the same way as the user directly provided responses received in step 403.

After user responses are received, step 404 immutably stores the received user responses in a data storage system. The data storage system may be blocks 101 of a blockchain 100. The responses may also be stored on distributed ledgers of a decentralized but verifiable system. Embodiments of the invention may permit the stored responses to be viewed and verified by users and other third parties to confirm their accuracy. Embodiments of the invention may utilize smart contracts, stored and executed on the blockchain 100, to automatically and securely receive 403 and store 404 the user responses. In such embodiments, the smart contracts may be publicly viewed and verified to improve transparency and build trust in system/method 400. The method 400 may also store or indicate respective user IDs with the received user responses to connect or otherwise associate the responses to: (i) specific users, (ii) their stored user attributes, demographics, and information, and (iii) their group assignment, while retaining and protecting user anonymity.

Next, step 405 calculates group responses, a unitary response, or both using the stored user responses of step 404. Some embodiments may configure a system processer to read the stored user responses on blocks 101 of blockchain 100 and automatically calculate the group responses and the unitary response. The group response of a group is calculated based on the user responses of users assigned to that group. The unitary response is calculated based on the user responses or the group responses as illustrated above in Equations 1 and 2 for non-limiting example. When calculating the unitary response, weights may be applied to user or group responses or both user and group responses, based upon the users' attributes, demographics, and/or information. Information regarding how the unitary and group responses, including any applied weights, are calculated can be made publicly available, for non-limiting example by providing the unitary response/group response definitions or representative equations through the user interface or even by storing the definitions/equations on a publicly viewable block 101 of blockchain 100.

Finally, an output is rendered 406 that displays the computed responses, e.g., the unitary response and the group responses. The output can be used by public policy makers to view how polled users within the defined groups responded to the query as well as how the user population as a whole responded. Supported by the output of step 406, a system processor, or other computing devices may present the poll (query) results in any desired format. For example, the system processors may present the poll (query) results in basic text format listing each group and that group's response with the optional inclusion of the calculated unitary response. Alternatively, the system processors/other computing devices present a full geographical map with one or more of the group's geographic boundaries displayed thereon and the system calculated group responses overlaid within the geographic boundaries. In general, the rendered output provides information on a multivariate grouping of subsets of the users and how each group responded to a posed query. The rendered output may be provided through a specialized output interface for the polling system/method 400 or through existing computer analysis and display systems and software. In embodiments, the output interface and display system may enable user interaction with overlays, visual effects (highlighting, color coding, texture, annotating, etc.) on group boundaries and data, view zoom level, etc. Various user interaction features and tools known in the art are suitable. A person skilled in the art, would understand that there are a wide variety of ways of rendering, presenting, and user-selectively manipulating (interacting with) an output display containing the computed group and unitary responses.

Digital Processing Environment

FIG. 5 illustrates a computer network or similar digital processing environment in which the present embodiments 1000 may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use protocols (TCP/IP, Bluetooth, etc.) to communicate with one another. Other electronic device/computer network architectures are also suitable.

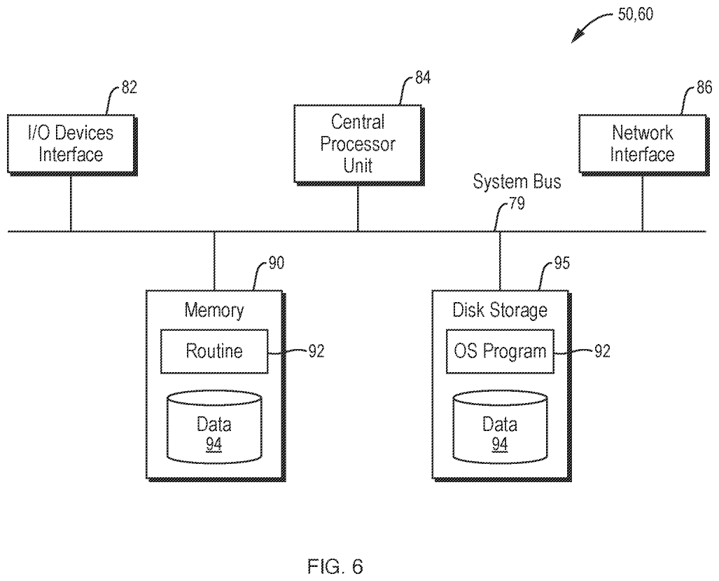

FIG. 6 is a diagram of the internal structure of a computer (e.g., client processor/device 50 or server computers 60) in the computer system of FIG. 5. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. 5). Memory 90 provides volatile storage for computer software instructions 92 and data 94 used to implement embodiments (e.g., blocks 101 of a blockchain, blockchain network nodes 105, distributed ledgers 107, method 400, polling engine 200, mapping member 410, calculation(s) such as Equations 1 and 2, smart contracts, algorithm(s), user interface(s), and rendered output(s)/user interactive display system described above). Disk storage 95 provides non-volatile storage for computer software instructions 92 and data 94 used to implement many embodiments. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the programs are a computer program propagated signal product 75 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

For example, as used herein ‘entity’ of a population may refer to any of: a person, voter, participant in a poll, interested party, individual, and the like.

What is claimed is:

1. A computer-implemented method of generating a multivariate population map, comprising:
For each entity of a population:
(i) automatically assigning the entity to a group based on geospatial attributes of the entity, the automatic assigning resulting in one or more groups;
(ii) digitally receiving an individual response of the entity to a query; and
(iii) immutably storing the received individual response in computer memory accessible by one or more processors;
for each group of the resulting one or more groups, automatically computing a group response, the group response being automatically computed by the one or more processors and being a function of the stored individual responses received from entities assigned to the group; and
rendering a multivariate population map displaying indications of the computed group responses.

2. The method of claim 1 further comprising;
computing a unitary response of the population, the one or more processors automatically computing the unitary response as a function of stored individual responses of each entity multiplied by a weighting factor associated with the group to which the entity is assigned, there being different weighting factors for different groups; and
wherein the population map also displays indication of the computed unitary response.

3. The method of claim 1 wherein the resulting one or more groups are one of: regional groupings, socioeconomic groupings, and statistical subpopulations.

4. The method of claim 1 wherein the geospatial attributes include one of a location of residence, a location of work, or a location of interest.

5. The method of claim 1 wherein the query is associated with query attributes and automatically assigning the entity to a group for each of the entities is further based on the query attributes.

6. The method of claim 5 wherein the query attributes are geospatial attributes.

7. The method of claim 1 wherein the population map is a geographical map.

8. The method of claim 7 wherein the rendering includes overlaying the displayed indications on the geographical map.

9. The method of claim 1 wherein the individual responses to the query are anonymous.

10. The method of claim 1 wherein the computer memory is located on at least one block of a blockchain.

11. A computer based polling system comprising:
One or more digital processors supporting a communications interface to entities in a population;
a polling engine executed by the one or more digital processors, for each entity in the population, the polling engine:
(i) automatically assigning the entity to a group based on geospatial attributes of the entity, the automatic assigning resulting in one or more groups;
(ii) digitally receiving an individual response of the entity to a query; and
(iii) immutably storing the received individual response in a ledger;
a mapping member responsive to the polling engine and executed by the one or more digital processors, for each group of the resulting one or more groups, the mapping member automatically computing a group response, the group response being computed as a function of the stored individual responses received from entities assigned to the group; and
the mapping member rendering a multivariate population map displaying indications of the computed group responses.

12. The system of claim 11 wherein the mapping member is further configured to:
compute a unitary response of the population, the mapping member automatically computing the unitary response as a function of stored individual responses of each entity multiplied by a weighting factor associated with the group to which the entity is assigned, there being different weighting factors for different groups; and
wherein the population map also displays indication of the computed unitary response.

13. The system of claim 11 wherein the resulting one or more groups are one of: regional groupings, socioeconomic groupings, and statistical subpopulations.

14. The system of claim 11 wherein the query is associated with query attributes, and the polling engine automatically assigning the entity to a group for each of the entities is further based on the query attributes.

15. The system of claim 14 wherein the query attributes are geospatial attributes.

16. The system of claim 11 wherein the population map is a geographic map.

17. The system of claim 11 wherein the individual responses to the query are anonymous.

18. The system of claim 11 wherein the ledger is located on at least one block of a blockchain.

19. A computer program product for generating a multivariate population map, the computer program product comprising:
one or more non-transitory computer-readable storage devices and program instructions stored on at least one of the one or more storage devices, the program instructions, when loaded and executed by a processor, cause an apparatus associated with the processor to, for each entity of a population:
(i) automatically assign the entity to a group based on geospatial attributes of the entity, the automatic assigning resulting in one or more groups;
(ii) digitally receive an individual response of the entity to a query; and
(iii) immutably store the received individual response in a ledger accessible by the processor;
for each group of the resulting one or more groups, automatically compute a group response, the group response being automatically computed by the processor and being a function of the stored individual responses received from entities assigned to the group; and
render a multivariate population map displaying indications of the computed group responses.

20. The computer program product of claim 19 wherein the program instructions, when loaded and executed by a processor, cause the apparatus associated with the processor to additionally:
compute a unitary response of the population, the processor automatically computing the unitary response as a function of stored individual responses of each entity multiplied by a weighting factor associated with the group to which the entity is assigned, there being different weighting factors for different groups; and
wherein the population map also displays indication of the computed unitary response.
